(19) United States
(12) Patent Application Publication
(10) Pub. No.: US 2010/0053665 A1
(43) Pub. Date: Mar. 4, 2010

(54) Print optimization mechanism

(76) Inventors: Stephen Goddard Price, Longmont, CO (US); Guy L. Johnston, Broomfield, CO (US); Edward Chatcavage, Longmont, CO (US); Ronald D. Parrish, Tucson, AZ (US); Reinhard Heinrich Hohensee, Boulder, CO (US); Arthur R. Roberts, Boulder, CO (US); Nenad Rijavec, Longmont, CO (US)

Correspondence Address: InfoPrint Solutions/ Blakely, 1279 Oakmead Parkway, Sunnyvale, CA, 94085-4040, US

(21) Appl. No.: 12/231,123

(22) Filed: Aug. 28, 2008

(51) Int. Cl. G06F 3/12

(52) U.S. Cl. 358/1.15

(57) ABSTRACT

A method is disclosed. The method includes receiving a print file, removing images from the print file, replacing each image with a reference to the image, storing each image removed from the print file; and printing the print file. Each image is retrieved from storage to be printed upon encountering a reference to the image during printing of the print file.

### FIELD OF THE INVENTION

This invention relates generally to the field of printing systems. More particularly, the invention relates to identifying resources prior to printing.

### BACKGROUND

Print systems include presentation architectures that are provided for representing documents in a data format that is independent of the methods that are utilized to capture or create those documents. One example of an exemplary presentation system is the (Advanced Function Presentation) AFP™ system developed by International Business Machines Corporation. According to the AFP system, documents may include combinations of text, image, graphics, and/or bar code objects in device and resolution independent formats. Documents may also include and/or reference fonts, overlays, and other resource objects, which are required at presentation time to present the data properly.

Other presentation systems include PostScript (PS) and Portable Document Format (PDF). Printing complex PS and/or PDF jobs requires a printer controller with sufficient performance to provide the throughput for which the printer is capable. PS and PDF files are typically processed at the printer, which includes a PS/PDF raster image processor (RIP) to convert the files to a printable bit map.

Thus, these files are typically large since they comprise almost all of the resources necessary to print, except for a standard set of fonts that may be stored at the printer. For instance, high resolution images in PS that appear in multiple places in the printed output of a job may be included many times in the job file, or just once, but must be processed each time. This results in an inefficiency in printing PS files.

Therefore, what is needed is an efficient mechanism for processing PS and PDF print jobs.

### SUMMARY

In one embodiment, a method is disclosed. The method includes receiving a print file, removing images from the print file, replacing each image with a reference to the image, storing each image removed from the print file; and printing the print file. Each image is retrieved from storage to be printed upon encountering a reference to the image during printing of the print file.

In another embodiment, a printing system is disclosed. The printing system includes a print application to transmit a PostScript (PS) file to be printed, a print server to receive the print file, remove images from the print file and replace each image with a reference to the image, a control unit to receive the removed images and the remainder of the print file, to store the images and to retrieve each image from storage to be printed upon encountering a reference to the image during printing of the print file, and a print engine to print the print file.

Another embodiment of a printing system discloses a print application to transmit a PostScript (PS) file or a Portable Document Format (PDF) file to be printed. The printer includes a control unit to remove images from the print file and replace each image with a reference to the image and a print engine to store the removed images at a buffer and to retrieve each image from buffer to be printed upon encountering a reference to the image during printing of the print file.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 illustrates a flow diagram for one embodiment of processing print files.

FIG. 3 illustrates a flow diagram for one embodiment of printing a print job;

FIG. 4 illustrates a flow diagram for another embodiment of processing print files; and

FIGS. 5A-5E illustrate one embodiment of an algorithm for processing PS and PDF files.

### DETAILED DESCRIPTION

A mechanism for the optimization of processing PS and PDF print jobs is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

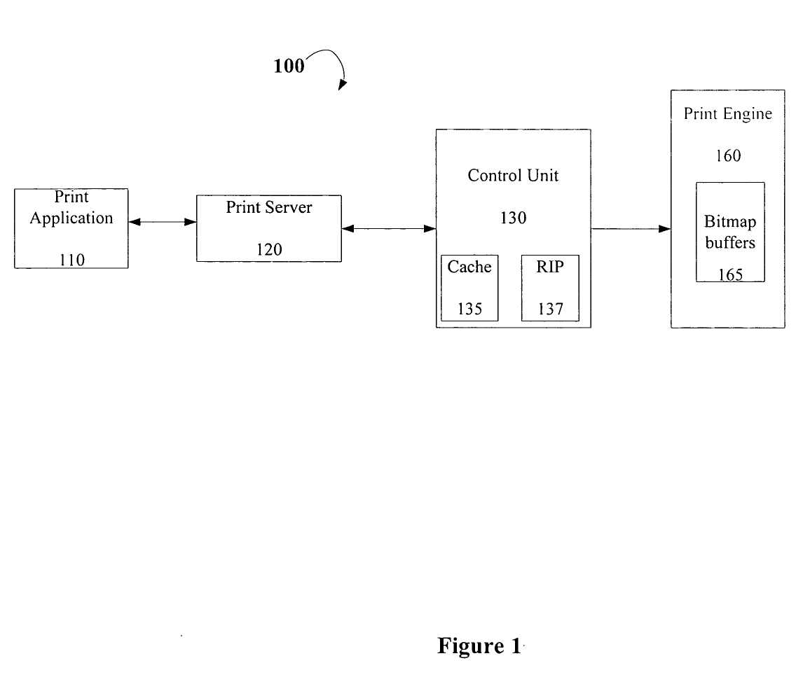

FIG. 1 illustrates one embodiment of a printing system 100. Printing system 100 includes a print application 110, a server 120, a control unit 130 and a print engine 160. Print application 110 makes a request for the printing of a document. In one embodiment, print application 110 provides a Mixed Object Document Content Architecture (MO:DCA) (also called an Advanced Function Presentation (AFP)) data stream to print server 120.

According to one embodiment, the AFP MO:DCA data streams are object-oriented streams including, among other things, data objects, page objects, and resource objects. In a further embodiment, AFP MO:DCA data streams include a Resource Environment Group (REG) that is specified at the beginning of the AFP document, before the first page. When the AFP MO:DCA data streams are processed by print server 120, the REG structure is encountered first and causes the server to download any of the identified resources that are not already present in the printer. This occurs before paper is moved for the first page of the job. When the pages that require the complex resources are eventually processed, no additional download time is incurred for these resources.

Print server 120 processes pages of output that mix all of the elements normally found in presentation documents, e.g., text in typographic fonts, electronic forms, graphics, image, lines, boxes, and bar codes. The AFP MO:DCA data stream is composed of architected, structured fields that describe each of these elements.

In one embodiment, print server 120 communicates with control unit 130 via an Intelligent Printer Data Stream (IPDS). The IPDS data stream is similar to the AFP data steam, but is built specific to the destination printer in order to integrate with each printer's specific capabilities and command set, and to facilitate the interactive dialog between the print server 120 and the printer. The IPDS data stream may be built dynamically at presentation time, e.g., on-the-fly in real time. Thus, the IPDS data stream is provided according to a device-dependent bi-directional command/data stream.

Control unit 130 processes and renders objects received from print server and provides sheet maps for printing to print engine 160. Objects are captured and stored in the printer capture storage at print engine 160.

According to one embodiment, print application 110 may also provide PS and PDF files for printing. In such an embodiment, PS and PDF files are efficiently processed by finding static images in a PS or PDF file, removing the images from the file, and replacing the images with references to the static images.

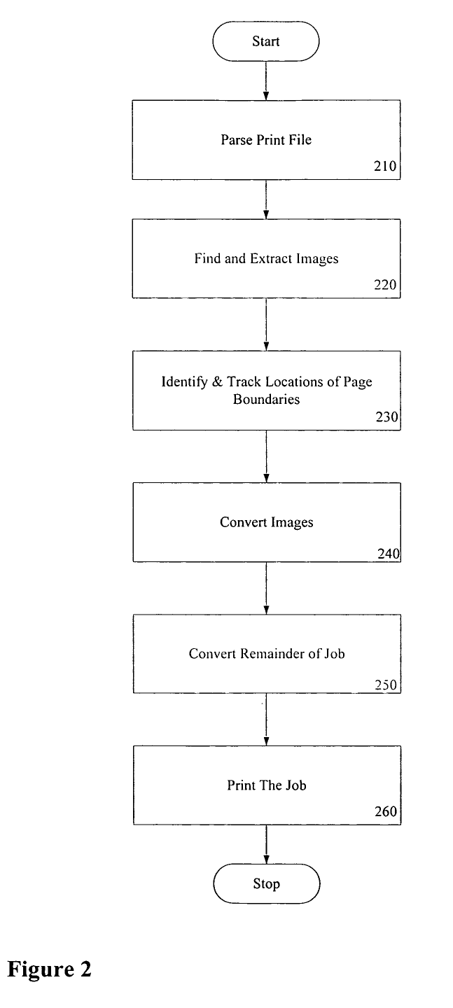

In one embodiment, PS and PDF files are printed by first processing them at print server 120 prior to being passed for printing at print engine 160. FIG. 2 illustrates a flow diagram for one embodiment of processing print files at print server 120. At processing block 210, a PS file is parsed. At processing block 220, all high resolution images are found, extracted and replaced with references to the images. At processing block 230, locations of page boundaries are identified and tracked. According to one embodiment, this process creates resource separation and page independence so that the PS file can be transformed into an AFP MO:DCA data stream prior to being printed. According to one embodiment, resource separation involves grouping the resources with the pages that use those resources. If used multiple times, the resources are replaced with resource references.

At processing block 240, the images are converted to a more efficient form. At processing block 250, the remainder of the print job is converted to the more efficient form, with the images being replaced by references to the extracted images. In one embodiment, the images and the remainder of the print job are converted to an IPDS data stream.

In such an embodiment, the IPDS form may include a set of pages each having one PS object, which is a “flattened” representation of the PS print job, where the term “flattened” refers to the PS being separated into independent IPDS pages and the images being removed and replaced with references to the images generated at processing block 250. In another embodiment, the IPDS form may include a set of pages each having one bitmap of the page contents that were not images in the first place and IPDS references to the images generated at processing block 250.

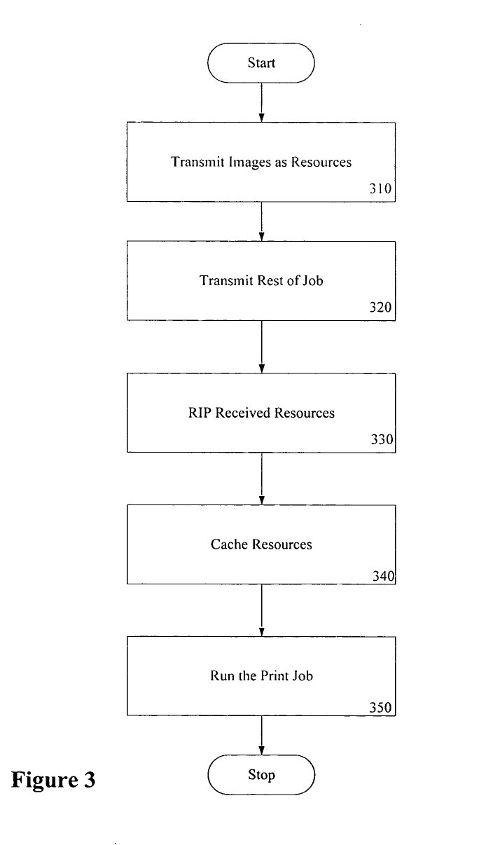

At processing block 260, the print job is forwarded for printing. FIG. 3 illustrates a flow diagram for one embodiment for printing the print job. At processing block 310, the images are transmitted to control unit 130 as resources. At processing block 320, the remainder of the print job is transmitted to control unit 130. At processing block 330, a RIP is performed on the received resources (to convert to CMYK bitmaps) at a RIP 137 in control unit 130.

At processing block 340, the resources are cached at a cache 135 within control unit 130. At processing block 350, the print job is printed at print engine 160. According to one embodiment, whenever the resources are called out during printing the data is pulled from the cache.

In one embodiment, PS and PDF files are forwarded directly to control unit 130 for processing prior to printing at print engine 160. In such an embodiment, the files are received and stored at control unit 130 as PS or PDF files. Subsequently, when the job is run, the files are processed by RIP 137 and some or all images are identified, extracted, RIPped and stored in the bitmap buffer 165 in bitmap buffer cards 165 at print engine 160. Then the job is RIPped except for the already-processed images, and forwarded to print engine 160 along with instructions to include the pre-RIPped images on the pages as needed.

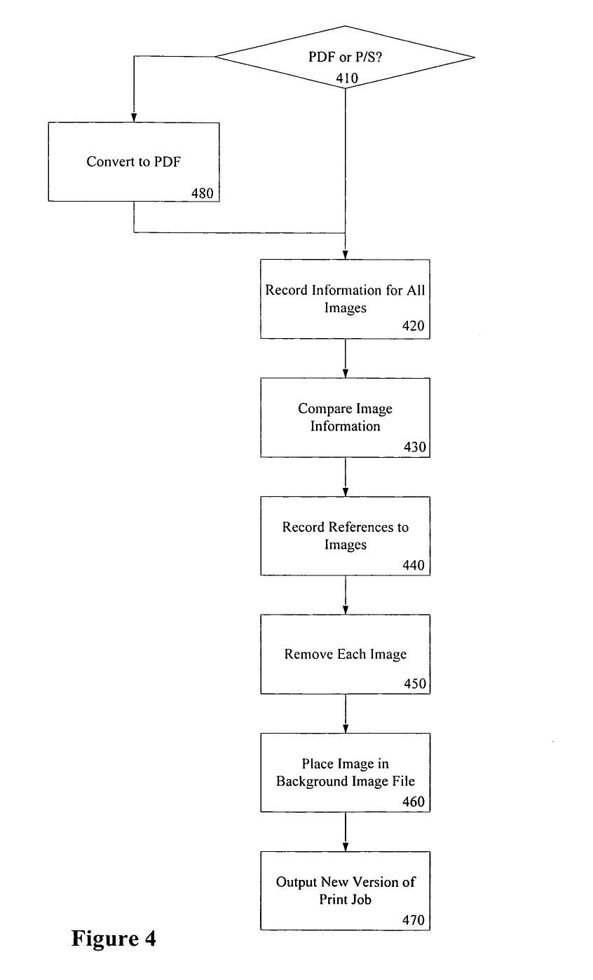

FIG. 4 illustrates a flow diagram for one embodiment of processing PS and PDF files at control unit 130. At processing block 410, it is determined whether the print job is a PS or PDF file. If the print job is a PDF file, the file is opened with a PDF Library (e.g., Adobe PDF library) and information is recorded for all images, processing block 420. In one embodiment, the size, location on page, rotation, color type (RGB, CMYK, gray, 8-bit/1-bit, etc.), and page number where used is noted for each image that is encountered.

At processing block 430, the image information is compared to information for previously found images. For instance, if there is a type and size match between image information, then the actual images are compared (using an identification scheme such as a good checksum). This process finds each image in the file, and all subsequent references to each original image in the file. At processing block 440, the usage information (e.g., page number, etc) for each image is recorded for all subsequent references to an image.

At processing block 450, each image is removed from the original print job file and is replaced with a reference to the image. For example, all instances of a first image is removed and replaced with a first reference, while all instances of a second image is removed and replaced with a second reference. At processing block 460, each image is placed in a background image file. At processing block 470, the modified version of the print job file with the image references is printed. In one embodiment, header information listing all the background images referenced may be included in the modified version.

Referring back to processing block 410, if the print job is a PS file, the PS file is converted to a PDF file at processing block 480. In such an embodiment, the entire PS job will be read in and processed. Additionally, as various objects are found indices and lists of objects are created and PDF data is created. Subsequently, processing blocks 420-470 are performed. In one embodiment, one or more of processing blocks 430-460 may occur while the PS file is being converted to PDF.

According to one embodiment, the saved images are converted to rasterized bitmaps. Such an embodiment may involve converting between color spaces (e.g., RGB to CMYK) changing resolution, applying a tone curve or color profile, and/or other transformations. In a further embodiment, each bitmap may be compressed.

The image extraction process illustrated in FIG. 4 enables the print job to be processed more efficiently during run time than if left in its original form. For instance, if the printer has a special buffer for bitmaps of images (e.g., a background overlay buffer in the bitmap buffer 165), as many of the extracted images as will fit in bitmap buffer 165 are stored before the job starts printing.

Subsequently, as the pages are processed, and as each extracted image is called out, commands are forwarded to the bitmap buffers 165 to place the desired image on the page in the indicated location. In one embodiment, bitmap buffers 165 require fully rasterized compressed bitmaps, so the images are converted to bitmaps and compressed, either at job start time or during the image extraction process discussed above.

If the printer has no special buffer, the images may still be rasterized in advance. In such an embodiment, the bitmaps are stored in control unit 130 and merged into the full-page bitmap as required. In an embodiment where the printer has special hardware for processing images (e.g., JPEG image decoding hardware), the images can be converted to that form (either at job start time or during the image extraction process, assuming they are not natively in that form within the job already) and forwarded to the hardware for rendering according to the hardware requirements.

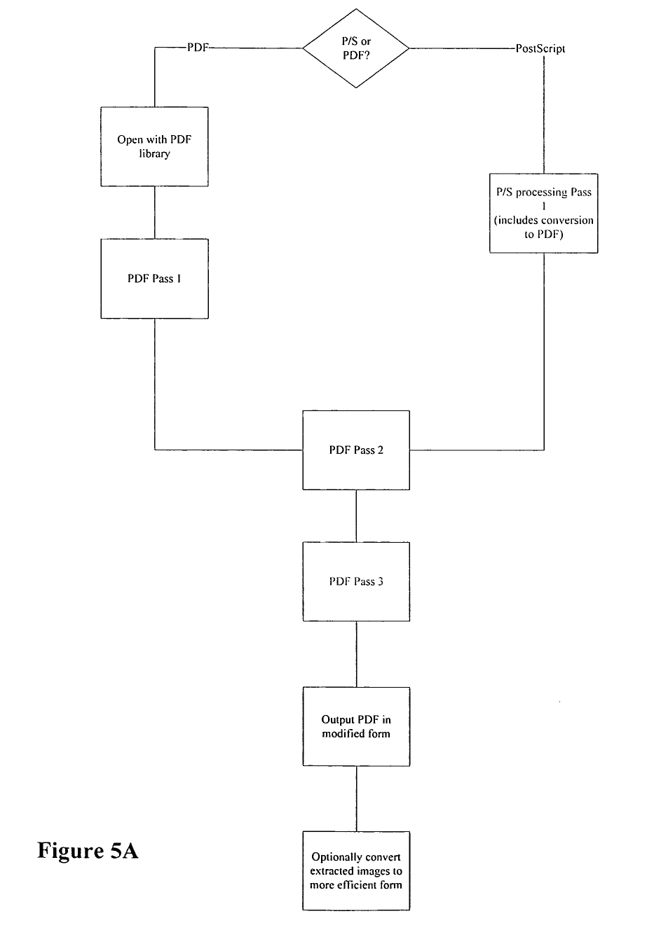

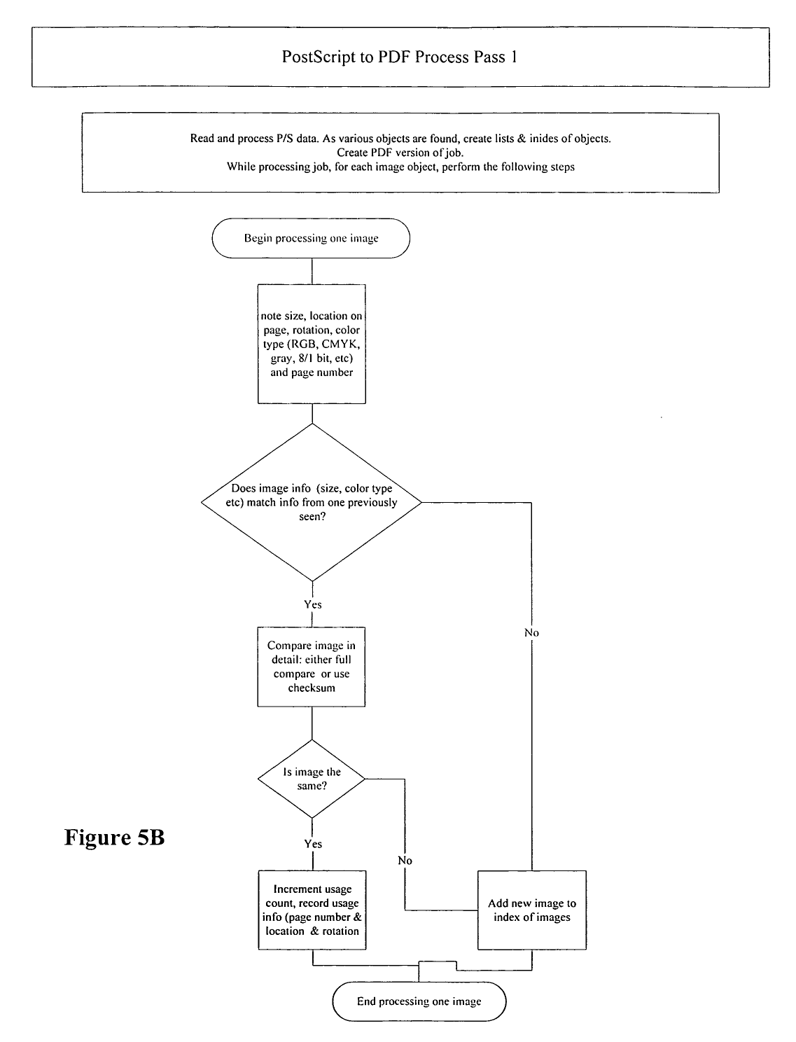

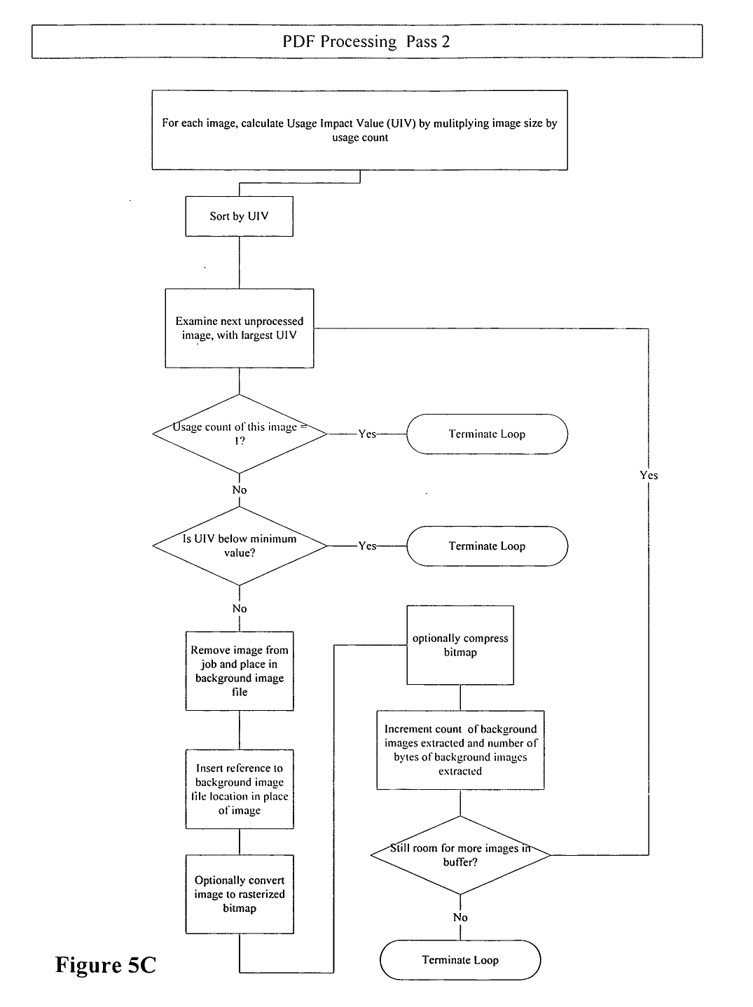

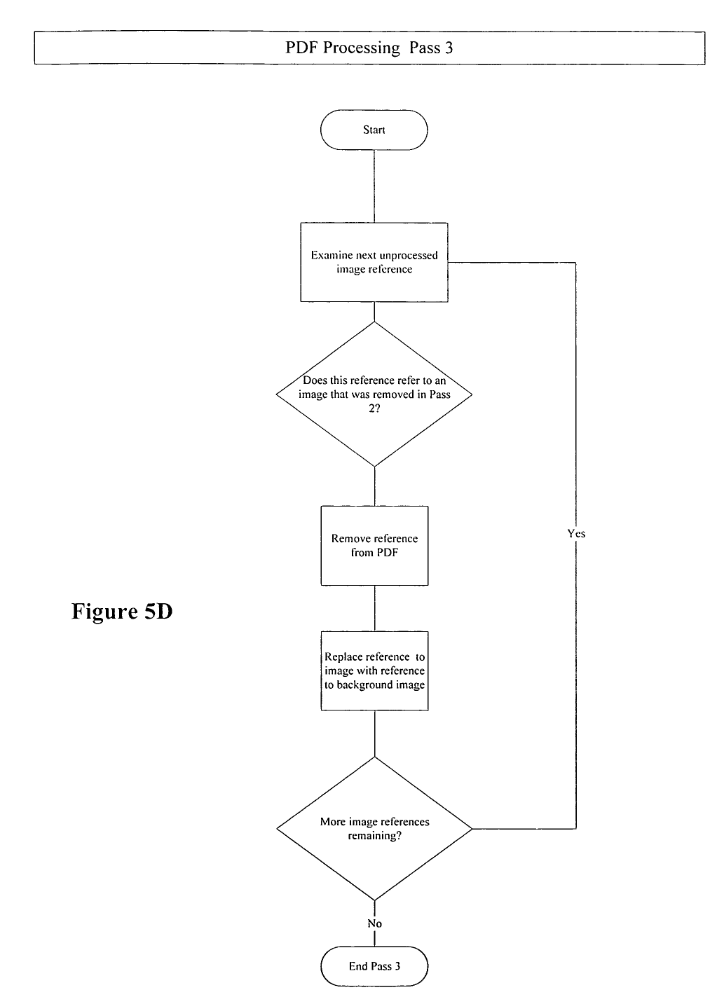

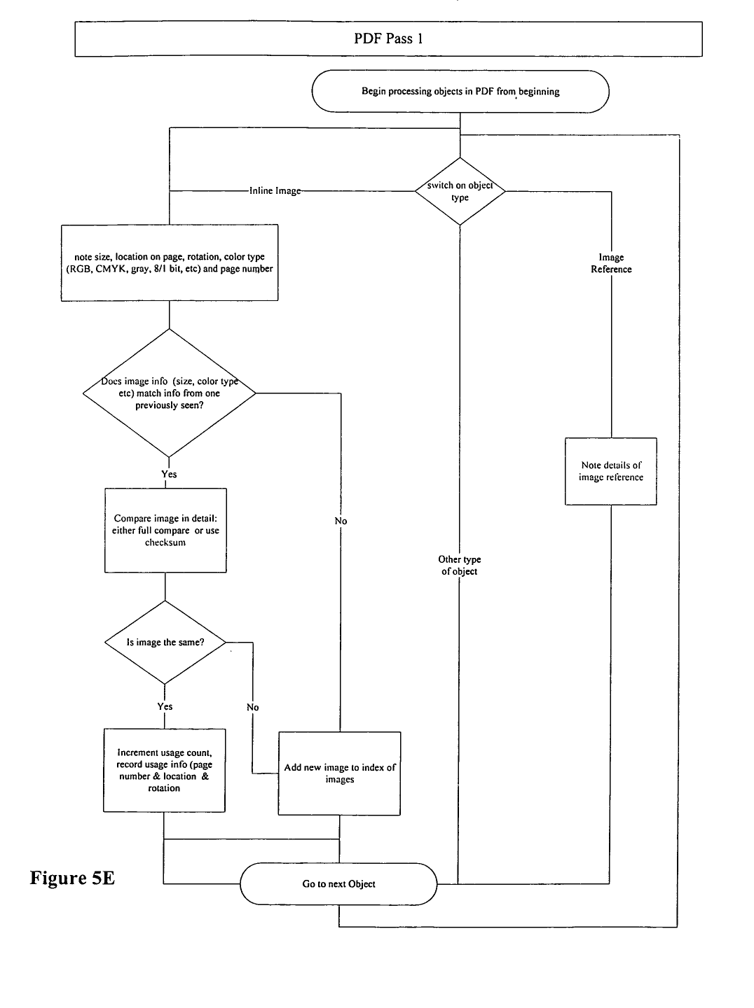

FIGS. 5A-5E are flow diagrams illustrating one embodiment of an in-depth algorithm for processing PS and PDF files.

The above-described image extraction processes provide efficient mechanisms to process PS and PDF print jobs.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method comprising:
receiving a print file;
removing images from the print file;
replacing each image with a reference to the image;
storing each image removed from the print file; and
printing the print file, wherein each image is retrieved from storage to be printed upon encountering a reference to the image during printing of the print file.

2. The method of claim 1 wherein the print file is one of a PostScript (PS) and Portable Document Format (PDF) file.

3. The method of claim 2 further comprising identifying locations of page boundaries in the print file after removing the images from the print file to create resource separation and page independence.

4. The method of claim 2 further comprising:
converting the images to a form supported by an Intelligent Printer Data Stream (IPDS) after removing the images from the print file; and
converting the remainder of the print file to an IPDS data stream.

5. The method of claim 2 wherein printing the print file comprises:
transmitting the images to a control unit as resources;
transmitting the remainder of the print file to the control unit as resources;
performing a raster image process (RIP) to convert the resources to a printable bit map; and
caching the resources.

6. The method of claim 1 further comprising determining at a printer control unit whether the print file is a PostScript (PS) file or a Portable Document Format (PDF) file.

7. The method of claim 2 further comprising:
converting the images to an Advanced Function Presentation (AFP) format after removing the images from the print file; and
converting the remainder of the print file to an IPDS data stream.

8. The method of claim 6 further comprising:
recording information for all images in the print file, wherein the information includes page number and location on the page where the image is used, and zero or more characteristics of the image such as size in bytes or a checksum of the image data; and recording all subsequent references to each recorded image.

9. The method of claim 8 further comprising comparing the recorded image information to find subsequent references to each image in the print file.

10. The method of claim 6 wherein printing the print file comprises:
performing a raster image process (RIP) to convert each image to a printable bit map;
storing each printable bit map corresponding to an image at a bitmap buffer;
transmitting a command to the bitmap buffer as each image is requested for printing; and
printing each printable bit map corresponding to an image on a page in an indicated location.

11. The method of claim 10 further comprising compressing each bitmap.

12. The method of claim 10 further comprising converting a PS file to a PDF file if the print file is a PS file.

13. A printing system comprising:
a print application to transmit a PostScript (PS) file to be printed;
a print server to receive the print file, remove images from the print file and replace each image with a reference to the image; and
a control unit to receive the removed images and the remainder of the print file, to store the images and to retrieve each image from storage to be printed upon encountering a reference to the image during printing of the print file; and
a print engine to print the print file.

14. The printing system of claim 13 wherein the print server further converts the images to a form supported by an Intelligent Printer Data Stream (IPDS) after removing the images from the print file, converts the remainder of the print file to an IPDS data stream and transmits the image resources and remainder of the print file to the control unit.

15. The printing system of claim 14 wherein the print server converts the images to an Advanced Function Presentation (AFP) format after removing the images from the print file

16. The printing system of claim 14 wherein the control unit performs a raster image process (RIP) to convert the resources to a printable bit map and caches the resources.

17. A printing system comprising:
a print application to transmit a file to be printed, wherein the file is one of a PostScript (PS) file or a Portable Document Format (PDF) file; and
a printer; including:
a control unit to remove images from the print file and replace each image with a reference to the image; and
a print engine to store the removed images at a buffer and to retrieve each image from buffer to be printed upon encountering a reference to the image during printing of the print file.

18. The printing system of claim 17 wherein the control unit performs a raster image process (RIP) to convert each image to a printable bit map, stores each printable bit map corresponding to an image at the buffer, and transmits a retrieve command to the buffer as each image is requested for printing.

19. The printing system of claim 17 wherein the control unit records information for all images in the print file and page number where each image is used and records all subsequent references to each recorded image.

20. The printing system of claim 16 wherein the control unit converts the print file to a PDF file if the print file is a PS file.
